(19) United States
(12) Patent Application Publication
(10) Pub. No.: US 2012/0094093 A1
(43) Pub. Date: Apr. 19, 2012

(54) PARTICLE BOARD WITH MIDDLE LAYER OF DEFIBRATED WOOD PARTICLES

(76) Inventor: Bo Nilsson, Morlunda (SE)

(21) Appl. No.: 13/124,594

(22) PCT Filed: Oct. 2, 2009
(86) PCT No.: PCT/SE09/51099

§ 371 Date: Nov. 4, 2011

(30) Foreign Application Priority Data
Oct. 16, 2008 (SE) 0802207-1

(51) Int. Cl. B32B 7/02; B27N 3/00

(52) U.S. Cl. 428/212; 156/62.2; 156/538; 156/583.1

(57) ABSTRACT

The invention relates to a wood particle board (5) and to a process for the manufacture of the same. The process involves the feed-out of a first quantity (9′) of glue-coated wood particles (25), producing a bottom particle mat (10′), feed-out of a second quantity (9″), comprising a homogeneous mixture of glue-coated defibrated wood particles, for producing an intermediate, voluminous mat (20) on top of the bottom particle mat (10′), feed-out of a third quantity (9′″) of glue-coated wood particles, producing a top particle mat (10′″) on top of said intermediate, voluminous mat (20), and compression of said fed-out quantities, to form a bottom (1), intermediate (7) and top layer (3) of the wood particle board (5).

### TECHNICAL FIELD

The present invention relates to a particle board according to the preamble to claim 1, a manufacturing process according to the preamble to claim 7, and also to a plant according to the preamble to claim 11 for the manufacture of such a particle board.

### BACKGROUND ART

The present invention can be assigned to the manufacturing industry for particle boards. Wood-based boards are in turn used, for example, in furniture manufacture and within the construction industry. Known particle boards which can currently be found on the market comprise a top and bottom layer containing wood particles of finer particle size, and an intermediate layer containing wood particles of coarser particle size. The particle board is manufactured under pressure and heat, with glue as the bonding agent. The wood particles are made of wood and can be constituted by, for example, sliced particles from roundwood, sawdust or chip particles.

An example of such a board is shown in WO 2005/023499 A1.

The intermediate layer is currently manufactured with a number of wood particles of a density of around 650-700 kg/m³, in which the wood particles of this intermediate layer are coarser than the wood particles of the top and bottom surface layers. These coarser wood particles are glued loosely together, wherein the intermediate layer has relatively large air pockets. When a board having such an intermediate layer is cross-cut, in the cut face of the cut a “crisp” surface is exposed, to which it can be hard to fix an edge strip. There is an obvious problem with such an intermediate layer having wood particles which are glued loosely together, which layer has very low density.

Particle boards comprising intermediate layers having string-shaped portions are also currently manufactured, in which portions the particles are tightly packed in accordance with the compactness in the intermediate layer of a conventional particle board, i.e. approximately 650-700 kg/m³. Wood particles in the intermediate layer between the string-shaped portions are less tightly packed than in the string-shaped portions and have a density of 350-500 kg/m³. The intermediate layer in such a particle board thus has varying density. Since the wood particles in this intermediate layer also, in the region between the string-shaped portions, are less tightly packed, air pockets can be formed, which give a “crisp” cut face. This type of known particle boards can be assigned to particle boards having a non-homogeneous intermediate layer of wood particles.

Thus particle boards have hitherto been manufactured with outer layers containing finer wood particles, which give a hard and strong surface layer, and with an intermediate layer containing coarser wood particles and air pockets, in order to save weight and material.

### DISCLOSURE OF INVENTION

In this application for the present invention, the term wood particle board is used despite the fact that the intermediate layer consists of defibrated wood fibers. The reason for this is that the bottom and top layer have wood particles, which bottom and top layers, first of all, are visible to an onlooker.

It is desirable to make further weight and material savings for the intermediate layer, something which many manufacturers of wood particle boards are seeking to achieve. It is also desirable to reduce the production time for a particle board. Likewise, one aim is at the same time to provide a cut face of the wood particle board which affords a good gluing surface. The objective is also to be able to provide a method for the manufacture of a lighter wood particle board, in which the production line of the manufacturer can be converted with simple means in order to make effective use of the equipment already present in the production line. Likewise, it is wished to reduce the transport costs for wood particle boards and, at the same time, reduce environmentally polluting emissions which can be caused by these transports. The objective is naturally also to overcome other problems with known wood particle boards and to further develop these same.

This has been achieved with the aid of the wood particle board defined in the introduction to the description and having the distinctive features defined in the characterizing part of claim 1.

A particle board has thereby been produced, comprising an intermediate layer of defibrated wood particles which is light and at the same time allows a cut face produced in the cross-cutting of the wood particle board to be sufficiently large for an edge strip to be satisfactorily glued. The intermediate layer containing defibrated wood particles is “fluffy” (voluminous) and light, and at the same time as strong as an intermediate layer of known wood particle boards. The transition between the intermediate layer containing defibrated wood particles and the top and bottom layer containing wood particles means, since the same type of wood material (deriving from the same volume of wood chips for processing) is advantageously used, that the hardening and joining together of glue-coated wood particles and glue-coated defibrated wood particles of the wood particle board is facilitated and no further applications need to be used to join together the various layers. In this way, the material consumption is also reduced in comparison with the prior art, which is very cost-effective when wood particle boards are manufactured in large quantities. It is thus also possible to reduce the pressing time for the compression of particle mats (forming the various layers) in the manufacture of the wood particle board, since the amount of moisture of the defibrated wood particles is lower than that of traditional intermediate particle mats with coarser particle size. The lower amount of moisture is due to the fact that the defibrated wood particles have a lower density than traditional wood particles and means that a smaller amount of water vapor needs to be pressed away, which reduces the pressing time.

Expediently, the size of the defibrated wood particles is smaller than a largest particle size of the first and third quantity of wood particles.

Bottom and top layers can thus be made light with a greater degree of air pockets in these layers surrounding the intermediate layer, which saves weight.

Alternatively, the size of the defibrated wood particles is larger than the various sizes of the wood particles of the bottom and top layer.

A reinforcement is thus achieved by means of the intermediate layer, at the same time as the intermediate layer comprising the voluminous quantity of defibrated wood fibers gives the wood particle board a low weight.

Preferably, the defibrated wood particles consist of finer wood particles and exposed wood fibers.

In this way, a voluminous “fluffy” intermediate layer has been produced, which requires minimal energy consumption to manufacture, since these defibrated wood particles can be produced by means of a mill (defibrator) and no finer grinding needs to be done. The wood particle board fulfills its function with the intermediate layer of defibrated wood particles consisting of exposed fibers and finer wood particles, at the same time as the wood particle board is light. In contrast to known MDF boards which are on the market, the wood particle board is more cost-effective to manufacture from an energy viewpoint (since a traditional MDF board requires greater grinding effort, with carbonization and heating of the wood material, to produce longer and finer wood fibers). Said defibrated wood particles are shorter than those of the MDF board and do not require carbonization. The density of the wood particle board is lower, by virtue of the fact that the bottom and top layer are constituted by wood particles with “air pockets” therebetween. The glue consumption is thus also less than for an MDF board of corresponding thickness.

Alternatively, the defibrated wood particles consist solely of exposed wood fibers.

In this way, a voluminous “fluffy” intermediate layer has been produced, which builds volume and is light. By utilizing wood substance, such as wood chips, that is shredded into wood particles which are then defibrated once or twice in a mill, it is possible to produce exposed wood fibers without the need to carbonize or heat the wood material.

Expediently, the defibrated wood particles have a size which is smaller than all the particle sizes of the first and third quantity.

The bottom and top layer can thus be produced with a still lesser density, since they have air pockets to a greater degree.

Preferably, the wood particles of the largest particle size of the first quantity are situated adjacent to the intermediate layer, and wood particles of a smallest particle size of the first quantity constitute material for the surface of the wood particle board.

In this way, the wood particle board can be produced with low weight, at the same time as the surface of the wood particle board is fine for less complicated surface treatment. The wood particles of the largest particle size of the first quantity are facing away from the surface of the wood particle board. This creates a lower weight of the bottom and top layer, at the same time as this more porous portion with larger particle size is “hidden” in the wood particle board.

Alternatively, the defibrated wood particles of the intermediate layer have a density of 520-580 kg/m³, preferably 540-560 kg/m³. These defibrated wood particles thus produce an intermediate layer having a lower density than the intermediate layer of traditional particle boards, which gives a low-weight wood particle board, at the same time as the edge working is facilitated. The lower density is achieved by virtue of the fact that the exposed wood fibers (and possibly wood particles of very small size) build volume and produce a “fluffy” material.

It is likewise desirable to be able to create a greater compression resistance for bottom and top particle mats for compression forming a bottom and top layer of the particle board. A greater compression resistance can be achieved by virtue of the time for the compression of the bottom and top particle mat being as long as possible.

This has been achieved with the aid of the method defined in the introduction to the description and having the steps defined in claim 7.

The intermediate, voluminous mat thus has the effect of making the time for the compression of the bottom and top particle mat as long as possible, since the defibrated wood particles of the fed-out intermediate, voluminous mat are constituted by a “fluffy” defibrated wood particle material which builds volume. The larger the volume, the longer the time for which the bottom and top particle mat are subjected to compression in the compression step.

Expediently, the feed-out steps are preceded by a step comprising the grinding-down of wood chips into wood particles, which wood particles on the one hand constitute said first and third quantity of wood particles, and on the other hand constitute particle substance for producing said second quantity of defibrated wood particles.

In this way, a manufacturer of a wood particle board with an intermediate layer of defibrated wood particles can easily and with a small amount of labor supplement an existing production line in a factory. At the same time, he can utilize one and the same storage site for the storage of said wood particles, produced from said wood chips, in the factory, which is advantageous from a logistics viewpoint.

Preferably, the compression step is preceded by a pre-pressing step.

The fed-out quantities can thus be evacuated on air, before being compressed under heat for hardening.

Alternatively, the feed-out steps involving the first and the third quantity are realized as a separation step, in which the largest size of respectively the first and third quantity is made to end up closest to the intermediate, voluminous mat produced with defibrated wood particles.

Finer wood particles can thus constitute the surface of the wood particle board and coarser wood particles are “hidden” adjacent to the intermediate layer.

It is likewise desirable to be able to produce a plant for the manufacture of said wood particle board, in which the production line of the manufacturer can be converted with simple means in order to make effective use of the equipment which is already present in the production line.

This has been achieved with the aid of the plant defined in the introduction to the description and having the distinctive features defined in claim 11.

In this way, a plant can be cost-effectively produced, which requires minimal supplementation to manufacture a light wood particle board which affords a cost-effective edge working.

Expediently, said feed-out device is arranged substantially in line between said feed-out members.

A manufacturer of wood particle board can thus easily exchange an existing feed-out device arranged to feed out a traditional intermediate layer containing coarser wood particles for a feed-out device arranged to feed out defibrated wood particles which build volume and have lower density.

Preferably, a wood particle storage member is connected on the one hand to a defibrator producing the defibrated wood particles, and on the other hand to said feed-out members.

In this way, one and the same storage site is utilized for the storage of wood particles which on the one hand are utilized for the bottom and the top layer, and on the other hand are utilized to produce the intermediate layer containing defibrated wood particles.

Alternatively, water distribution members are arranged to distribute water under the first quantity of wood particles and over the third quantity of wood particles prior to said compression under heat.

The water situated on a compression tool is thus converted to steam by the heat, which steam expands in the second quantity comprising defibrated wood particles. In this way, heat can be supplied to the second quantity. The more voluminous the intermediate layer, the harder it is to supply heat to this. By producing steam in this way, it is possible in a simple manner to supply heat also to the second quantity of defibrated wood particles. It has been shown that approximately 100 grams of water per square meter is effective for the manufacture of a wood particle board having an intermediate layer of about 5-15 mm.

### BRIEF DESCRIPTION OF DRAWINGS

The present invention will now be described in greater detail with the aid of the appended drawings, in which:

FIGS. 1a and 1b schematically show the compression step for producing a wood particle board according to the prior art;

FIGS. 2a, 2b and 2c schematically show the compression step for producing a wood particle board according to one embodiment of the invention;

FIGS. 3a, 3b, 3c, 3d and 3e schematically show a wood particle board according to different embodiments of the invention;

FIG. 4 schematically shows a plant for the manufacture of a wood particle board shown in FIG. 3a;

FIG. 5 schematically shows an enlarged portion of the produced wood particle board in FIG. 4;

FIG. 6 schematically shows a plant according to a second embodiment of the invention for the manufacture of a wood particle board; and

FIG. 7 schematically shows a part of a plant according to a third embodiment of the invention.

### MODE(S) FOR CARRYING OUT THE INVENTION

The present invention will now be described with reference to the figures. Details of no importance to the invention are not included, for the sake of clarity.

By the term particle mat is meant the wood particle pulp, consisting of glue-coated and distributed wood particles, prior to hot pressing. By the term wood particle board is meant either a ready-pressed particle board fed out from the warm press of a production line, or a refined particle board, which is sawn up with a length and breadth in accordance with customer requirements.

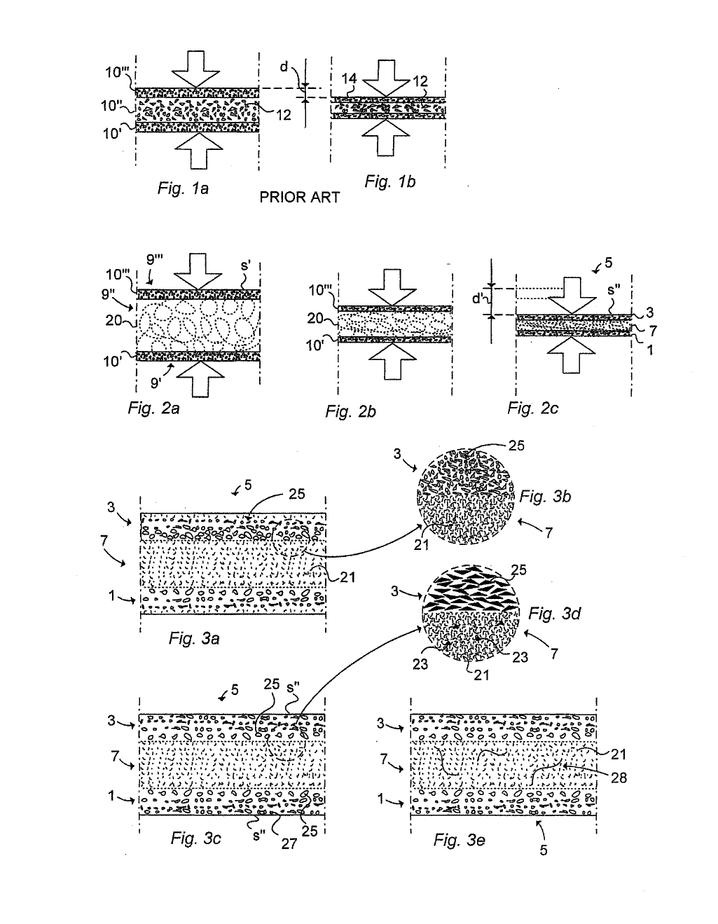

FIG. 1a shows schematically according to the prior art how a bottom particle mat 10′, an intermediate particle mat 10″ and a top particle mat 10′″ are in position for commenced compression. The intermediate particle mat 10″ consists of wood particles 12 which are coarser than the wood particles of the bottom and top particle mat 10′, 10′″. Upon completion of the compression, shown in FIG. 1b, the surface 14 of the top particle mat 10′″ has been displaced by the distance d. That is to say, the relatively compact intermediate particle mat 10″ means that the bottom 10′ and top 10′″ particle mats are compressed for a relatively short time.

It is desirable, however, to produce a greater compression resistance in order to be able to create in the manufacturing process a greater density of the bottom 1 and top layer 3 of a wood particle board 5 according to a first embodiment shown in FIG. 2c. FIG. 2a shows how the intermediate particle board 10″ in FIG. 1a has been replaced with an intermediate, voluminous mat 20 constituted by a homogeneous mixture of glue-coated, defibrated, exposed wood particles (wood fibers 21, see FIG. 3b).

A process for the manufacture of the wood particle board 5, comprising wood particles obtained from untreated wood material, is thus shown schematically in part in FIGS. 2a-2c. The wood particle board 5 comprises the bottom layer 1, an intermediate layer 7 and a top layer 3. The process involves the steps that firstly a first quantity 9′ of glue-coated wood particles is fed out, producing the bottom particle mat 10′. Next a second quantity 9″, comprising a homogeneous mixture of glue-coated, defibrated wood particles, is fed out, for producing the intermediate, voluminous mat 20 on top of the bottom particle mat 10′. After this, a third quantity 9′″ of glue-coated wood particles is fed out, producing the top particle mat 10′ on top of said intermediate, voluminous particle mat 20 (see FIG. 2a).

Once the quantities 9′, 9″, 9′″ are fed out, a compression step takes place (see FIG. 2b), in which the fed-out quantities are compressed under heat, to form the bottom 1, intermediate 7 and top layer 3 of the wood particle board 5.

The voluminous mat 20 of defibrated wood particles means that the distance d′ (a displacement of the surface s′ of the top particle mat 10′″ into a definitive position for this surface, denoted by s″, following completed compression) is longer than the distance d for a traditional wood particle board. This longer distance d′ means that the compression takes place more slowly, resulting in a greater compression resistance. This greater compression resistance gives a greater surface density of the wood particle board 5 shown in FIG. 2c relative to the known wood particle board shown in FIG. 1b. In FIG. 2b is shown how the mats 10′, 10′″, 20 have been compressed by half the distance corresponding to the initial thickness of the strewn-out mats 10′, 10″, 10′″ in FIG. 1a.

FIG. 3a shows schematically a wood particle board 5 according to a first embodiment. The wood particle board 5 comprises wood particles obtained from untreated wood material and comprises a bottom layer 1 consisting of a first quantity of wood particles of different particle size, an intermediate layer 7 consisting of a second quantity of wood material, and a top layer 3 consisting of a third quantity of wood particles of different particle size, in which the second quantity is constituted by a homogeneous mixture of defibrated wood particles in which the size of the defibrated wood particles is smaller in magnitude than a largest particle size of the first and third quantity of wood particles.

FIG. 3a illustrates schematically that the wood particles of the bottom 1 and top 3 layer for the most part comprises a mixed wood particle size of particles 25 (0.25-10 mm, preferably 2-8 mm), which for the most part have a larger size than the defibrated wood particles in the intermediate layer 7. The defibrated wood particles consist solely of exposed wood fibers 21. In this way, a voluminous “fluffy” intermediate layer has been produced, which builds volume and is light. By utilizing wood substance, such as wood chips, that is shredded into wood particles which are then defibrated once or twice in a mill, it is possible to produce exposed wood fibers without the need to carbonize or heat the wood material. FIG. 3b is an enlarged segment of the section through the wood particle board 5 in FIG. 3a.

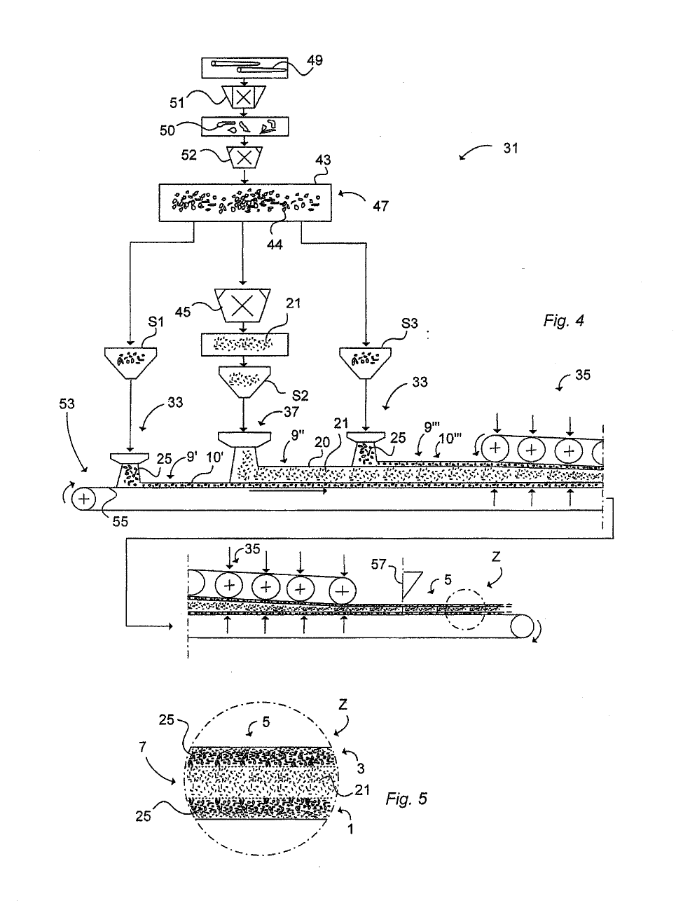

In FIG. 3c is shown a second embodiment of the wood particle board 5. The defibrated wood particles are constituted by finer wood particles 23 and exposed wood fibers 21. In this way, a voluminous “fluffy” intermediate layer 7 has been produced, which requires minimal energy consumption to manufacture, since these defibrated wood particles can be produced by means of a mill (defibrator) (see FIG. 4) and no finer grinding needs to be done. The wood particle board 5 fulfills its function with the intermediate layer 7 constituted by defibrated wood particles consisting of exposed wood fibers 21 and finer wood particles 23, at the same time as the wood particle board 5 is light. The density of the wood particle board 5 is lower, by virtue of the fact that the bottom 1 and top 3 layer are made of coarser wood particles 25 with “air pockets” therebetween. FIG. 3d is an enlarged segment of the section through the wood particle board 5 in FIG. 3c. In this it is shown schematically that the defibrated wood particles (the wood fibers 21 and the wood particles 23) have a size which is smaller than all the particle sizes of the first (bottom layer 1) and third quantity (top layer 3). The bottom and top layer can thus be produced with a still lesser density, since they have air pockets to a greater degree. The wood particles 25 of the largest particle size of the first quantity are situated adjacent to the intermediate layer 7, and wood particles 27 of a smallest particle size of the first quantity constitute the top surface s″ of the wood particle board. In this way, the wood particle board 5 can be produced with low weight, at the same time as the surface s″ of the wood particle board is even and hard. The wood particles 25 of the largest particle size of the first quantity are thus facing away from the surface s″ of the wood particle board 5. This creates a lower weight of the bottom 1 and top 3 layer, at the same time as this more porous portion of the bottom 1 and top 3 layer with larger particle size is “hidden” in the wood particle board.

In FIG. 3e, a wood particle board 5 according to a third embodiment is shown. The intermediate layer 7 has here been supplemented with a lower number of long wood fibers 28 for reinforcement purposes. Otherwise, this wood particle board conforms to that shown in FIG. 3c. The intermediate layer has fractions from 0.25 to 10 mm of defibrated wood particles (exposed wood fibers).

The defibrated wood particles of the intermediate layer 7 for the abovementioned embodiments have a density of 520-580 kg/m³, preferably 540-560 kg/m³. These defibrated wood particles thus produce an intermediate layer 7 having a lower density than the intermediate layer of traditional particle boards, which gives a low-weight wood particle board 5, at the same time as the edge working is facilitated. The lower density is achieved by virtue of the fact that the exposed wood fibers 21 (and possibly wood particles 23 of very small size) build volume and give a porous material.

A further embodiment signifies that the bottom 1 and top 3 layer consist of wood particles of substantially the same particle size.

Yet another embodiment signifies that the size of the defibrated wood particles is larger in magnitude (fraction size) than a largest particle size of the wood particles of the first and third quantity of wood particles in the bottom and top layer.

The prior art for wood particle boards suffers from the drawback that the cost of the materials for the middle layer, such as particles and bonding agent, is large. Known wood particle boards are likewise heavy, which means heavy transports and unnecessary wear upon the external environment. Through the use of defibrated wood particles in a homogeneous intermediate layer, these drawbacks, of a wood particle board according to the embodiments with same thickness and surface hardness, are eliminated.

FIG. 4 shows schematically a plant 31 for the manufacture of a wood particle board 5 shown in FIG. 3a. The plant 31 is thus arranged to produce a wood particle board comprising a bottom layer 1 consisting of a first quantity of wood particles, an intermediate layer 7 constituted by a homogeneous mixture of defibrated wood particles, and a top layer 3 consisting of a third quantity of wood particles. The plant 31 comprises feed-out members 33 for the feed-out of wood particles, compression members 35 for the simultaneous compression of fed-out wood particles, and also a feed-out device 37 for feeding out a second quantity comprising a homogeneous mixture of glue-coated defibrated wood particles producing the intermediate, voluminous mat 20 for compression producing said intermediate layer 7, which compression takes place under said simultaneous compression of the first and third quantity. The feed-out device 37 for feeding out defibrated wood particles is arranged substantially in line between said feed-out members 33.

A wood particle storage member 43 is connected on the one hand to a defibrator 45 producing the defibrated wood particles (by the grinding of wood particles 44), and on the other hand to said feed-out members 33. One and the same storage site 47 can be utilized for the storage of wood particles which on the one hand are utilized for the bottom 1 and the top 3 layer and on the other hand are utilized to produce the intermediate layer 7 containing defibrated wood particles. Debarked logs 49 are shredded into chips 50 by means of a shredder 51. The chips 50 are ground into the wood particles 44 by means of a mill 52 and are stored at the storage site 47. These wood particles 44 are used to produce the first 9′ and third 9′″ quantity of wood particles via a first station S1 and third station S3 respectively, and are fed to a defibrator 45 for producing the defibrated wood particles for forwarding to a second station S2. This direct process for producing the defibrated fibers is simpler than the prior art, in which the wood material has to be carbonized and heated. The wood particles 44 here correspond to the wood particles 25 for the bottom 1 and top 3 layer.

The plant 31 comprises a conveyor 53 having a belt 55, on which the first quantity 9′ of wood particles is first strewn out, forming the bottom mat 10′. After this, the defibrated wood particles are strewn out on the bottom mat 10′, forming the voluminous mat 20, and thereafter, on this voluminous mat 20, the top mat 10′″ containing wood particles. The conveyor 53 continuously transports the mats 10′, 20, 10′″ to the compression member 35, in which compression takes place for production of the wood particle board 5, which is cross-cut by means of the cutting plant 57.

FIG. 5 shows schematically an enlarged portion of the produced wood particle board 5 in FIG. 4. The second quantity 9″ for the intermediate layer 7 in the wood particle board 5 is constituted by a homogeneous mixture of defibrated wood particles, in which the size of the defibrated wood particles (i.e. the exposed wood fibers) is smaller in magnitude than a largest particle size of the wood particles in the surrounding layers 1, 3.

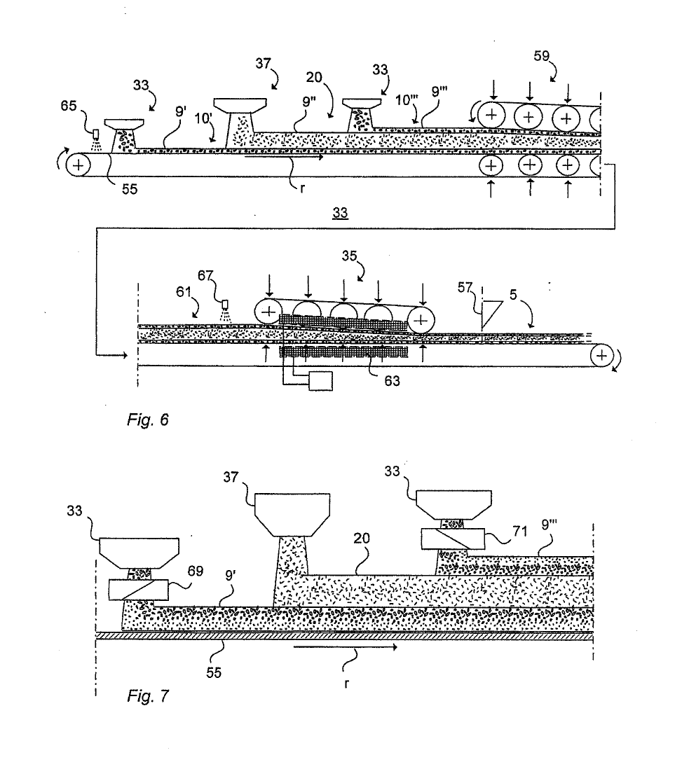

FIG. 6 shows schematically a plant 31 according to a second embodiment of the invention for the manufacture of a wood particle board 5. This plant 5 differs from the preceding one shown in FIG. 4 in that a pre-pressing plant 59 is arranged before the compression member 35, viewed in the motional direction r of the belt 55. The pre-pressing plant 59 simultaneously pre-presses the particle mats 10′, 10′″, the wood particles of which have previously been coated with glue, and the voluminous mat 20, the exposed fibers of which have likewise been glue-coated, whereupon the majority of the air present between the particles and between exposed fibers is pressed out. The ready-strewn and pre-pressed pulp 61 is forwarded to a hot press, such as compression members 35, and is compressed under pressure and heat. The hot press is furnished with heating elements 63. The hot-pressing takes place under a temperature of around 160-230° C. and, by virtue of the hardening properties of the glue, the solid (hard) structure of the particle board 1 is prepared. Boards 5 are cross-cut in suitable length and are then cooled. A first set of water distribution nozzles 65 is placed before the feed-out member 33, viewed in the motional direction r, so as to distribute a quantity of water onto the belt 55. Expediently, the water quantity is 100 gr/m². A second set of water distribution nozzles 67 is placed before the compression member 35, viewed in the motional direction r. The water quantities around the pre-pressed mat 61 are vaporized during the hot pressing, whereupon steam expands in the second quantity comprising defibrated wood particles. In this way, heat can be supplied to the second quantity. The more voluminous the intermediate layer is, the harder it is to supply heat to this, which heat, of course, is required to harden the glue with which the defibrated wood fibers have been coated. By producing steam in this way, it is easily possible to supply heat from the heating elements 63 to the second quantity of defibrated wood particles in a simple manner.

FIG. 7 shows schematically a part of a plant according to a third embodiment of the invention. According to this embodiment, the feed-out steps involving the first and the third quantity are realized as a separation step, in which the largest size of wood particles of respectively the first and third quantity is made to end up closest to the intermediate, voluminous mat produced with defibrated wood particles. A first separation member 69 is arranged to produce the first quantity 9′. A second separation member 71 is arranged to produce the third quantity 9′″.

The present invention is not limited to the above-described embodiments, but rather combinations of the described embodiments and similar solutions can be found within the scope of the invention.

Other types of production lines from the above-described can be used. Apart from a continuous press, a so-called cycle press can be used. All parameters for the manufacture of a particle board according to the present invention can be controlled and monitored from a control room.

1. A wood particle board comprising wood particles obtained from untreated wood material, the wood particle board comprising:
a bottom layer consisting of a first quantity of wood particles of different particle size,
an intermediate layer consisting of a second quantity of wood material, and
a top layer consisting of a third quantity of wood particles of different particle size,
the second quantity is constituted by a homogeneous mixture of defibrated wood particles, characterized by that the wood particles of the largest particle size of the first quantity are situated adjacent to the intermediate layer, and wood particles of a smallest particle size of the first quantity constitute material for the surface of the wood particle board.

2. The wood particle board as claimed in claim 1, wherein the size of the defibrated wood particles is smaller than a largest particle size of the first and third quantity of wood particles.

3. The wood particle board as claimed in claim 1, wherein the defibrated wood particles consist of finer wood particles and exposed wood fibers.

4. The wood particle board as claimed in claim 1, wherein the defibrated wood particles consist solely of exposed wood fibers.

5. The wood particle board as claimed in claim 1, wherein the defibrated wood particles have a size which is smaller than all the particle sizes of the first and third quantity.

6. The wood particle board as claimed in claim 1, wherein the defibrated wood particles of the intermediate layer have a density of 520-580 kg/m³, preferably 540-560 kg/m³.

7. A process for the manufacture of a wood particle board comprising wood particles obtained from untreated wood material, the wood particle board comprising a bottom layer, an intermediate layer and a top layer, which process comprises the steps:
feed-out of a first quantity of glue-coated wood particles, producing a bottom particle mat,
feed-out of a second quantity, comprising a homogeneous mixture of glue-coated defibrated wood particles, for producing an intermediate, voluminous mat on top of the bottom particle mat,
feed-out of a third quantity of glue-coated wood particles, producing a top particle mat on top of said intermediate, voluminous mat, wherein the feed-out steps involving the first and the third quantity are realized as a separation step, in which the largest size of respectively the first and third quantity is made to end up closest to the intermediate, voluminous mat produced with defibrated wood particles, and
compression of said fed-out quantities, to form the bottom, intermediate and top layer of the wood particle board.

8. The process as claimed in claim 7, wherein the feed-out steps are preceded by a step comprising the grinding-down of wood chips into wood particles, which wood particles on the one hand constitute said first and third quantity of wood particles, and on the other hand constitute particle substance for producing said second quantity of defibrated wood particles.

9. The process as claimed in claim 7, wherein the compression step is preceded by a pre-pressing step.

10. A plant arranged to manufacture a wood particle board comprising a bottom layer consisting of a first quantity of wood particles, an intermediate layer constituted by a homogeneous mixture of defibrated wood particles, and a top layer consisting of a third quantity of wood particles, which plant comprises feed-out members for the feed-out of wood particles, and compression members for the simultaneous compression of fed-out wood particles, wherein the plant also comprises a feed-out device for feeding out a second quantity comprising a homogeneous mixture of glue-coated defibrated wood particles producing an intermediate, voluminous mat, wherein the compression member for the simultaneous compression is also arranged to compress the intermediate, voluminous mat into said intermediate layer.

11. The plant as claimed in claim 10, wherein said feed-out device is arranged substantially in line between said feed-out members.

12. The plant as claimed in claim 10, wherein a wood particle storage member is connected on the one hand to a defibrator producing the defibrated wood particles, and on the other hand to said feed-out members.

13. The plant as claimed in claim 10, wherein water distribution members are arranged to distribute water under the first quantity of wood particles and over the third quantity of wood particles prior to said compression under heat.
